(19) United States
(12) Patent Application Publication
(10) Pub. No.: US 2022/0161393 A1
(43) Pub. Date: May 26, 2022

(54) TOOLS, APPARATUSES AND METHODS FOR SHARPENING OF CUTTING EDGES

(71) Applicant: Tore EKLUND, Motala (SE)

(72) Inventor: Tore EKLUND, Motala (SE)

(21) Appl. No.: 17/438,123

(22) PCT Filed: Mar. 11, 2020
(86) PCT No.: PCT/SE2020/050264

§ 371 Date: Sep. 10, 2021

(30) Foreign Application Priority Data
Mar. 13, 2019 (SE) 1930088-8

(51) Int. Cl. B24D 15/04; B24D 15/08; B24B 41/00; B26D 7/12; B24B 3/46

(52) U.S. Cl. CPC B24D 15/04; B24D 15/081; B26D 2210/02; B26D 7/12; B24B 3/463; B24B 41/002

(57) ABSTRACT

A grinding- and polishing tool in combination, comprising a stave which has an edge-treatment side comprising a primary treatment area covering a part of its length, and which in the length direction of the stave is followed by an adjoining secondary treatment area covering another part of the length of the stave. The treatment areas are oriented at intersecting planes such that an intermediate angle between adjoining primary and secondary treatment areas is other than 180°. Also disclosed are a tool assembly, an attachment for a food slicer machine, and a method, all of which are unique implementations of the combined grinding- and polishing tool.

### TECHNICAL FIELD OF THE INVENTION

The present invention relates to a grinding- and polishing tool in combination, a tool assembly, an attachment for a food slicer machine and a method for treating cutting edges of knives and circular cutting blades.

### BACKGROUND AND PRIOR ART

The invention can be referred to the category of grinding tools and apparatuses that comprises a couple of edge-treating staves which are individually mounted in respective holders. The holders are located side by side and arranged movable in parallel paths and in mutually opposite directions. The tools extend inclined from the holders at intersecting directions with oppositely positioned treatment surfaces forming between them a V-shaped groove which has the shape of an edge profile for simultaneous treatment of the opposite sides of a cutting edge, when the same is inserted in the groove and set in motion while being in contact with the treatment surfaces.

Forming an efficient cutting edge usually involves the operations of grinding and polishing/honing. During grinding there is effectuated a removal of material in order to remove indentations and other damages from the edge. Grinding usually results in a raw edge (secondary edge) with an uneven and fragile point. In a following step, the raw-edge is honed or polished to receive a slightly more obtuse edge angle (primary edge). The primary edge has a higher resistance to wear and thus maintains its sharpness for a longer time. A tool with coarser surface roughness and higher capacity for removing material is used during grinding, than during the polishing/honing operation. In other words, grinding and polishing/honing are two distinctly separated moments in the process of forming a sharp and long-lasting cutting edge.

WO2018/182483 A1 and DE 20 2017 005 641 U1 are representatives for this type of tools and apparatuses. A common feature in the named devices is that the staves that carry the edge treatment surfaces need to be substituted or rotated in order to present a treating surface of other surface roughness and abrasive efficiency, when shifting from grinding to polishing or honing.

### SUMMARY OF THE INVENTION

An object for the present invention is to provide tools and apparatuses which avoid the drawbacks of prior art, and which simplifies shifting between the operations of grinding and polishing/honing of a cutting edge.

Another object of the invention is to provide tools, apparatuses and methods for grinding and polishing/honing of a circular cutting blade in a food slicer machine, without need for dismantling the cutting blade.

In order to meet these objects, the invention primarily provides a grinding- and polishing tool in accordance with appended claim 1. Secondarily, the invention provides a tool assembly implementing the teachings of the invention of claim 1. Thirdly, the invention provides an attachment for grinding and polishing/honing of a circular cutting blade in a food slicer machine, implementing the tools and the tool assembly of the invention.

In a first aspect of the invention, briefly, there is provided a grinding- and polishing tool in combination, comprising a stave which has an edge-treatment side comprising a primary treatment area covering a part of its length, and which in the length direction of the stave is followed by an adjoining secondary treatment area covering another part of the length of the stave. The treatment areas are oriented at intersecting planes such that an intermediate angle between the first and second treatment areas, as measured in the length direction of the stave, is other than 180°.

In result, an advantage and technical effect provided by this solution is that one singular tool only is required to achieve both the primary edge (polished edge) and the secondary edge (raw edge) simply by moving the position of the cutting edge along the stave from one treatment area to the other, in one continuous edge treatment operation without the cutting edge leaving the tool.

In one embodiment, the intermediate angle between the primary and secondary treatment areas is greater than 180°. In this embodiment, the intermediate angle between primary and secondary treatment areas may be in the order of 180.5°-183.5°, e.g.

In an alternative embodiment, the intermediate angle between the primary and secondary treatment areas is less than 180°. In this embodiment the intermediate angle may be in the order of 176.5°-179.5°, e.g.

When simultaneously applied to both sides of a cutting edge in a grinding apparatus, the grinding- and polishing tools result in a primary edge having an edge angle that is 1°-7° greater than the edge angle of the secondary edge, which is considered an advantageous difference in many slicing or cutting tools. Naturally, other angles may be appropriate in other applications.

The primary treatment area has a finer surface roughness effective for polishing or honing, whereas the secondary treatment area has a coarser surface roughness effective for grinding.

In one embodiment, the secondary treatment area of coarser surface roughness reaches from a lower or mounting end of the stave towards a longitudinal centre of the stave, whereas the primary treatment area of finer surface roughness reaches towards the longitudinal centre of the stave from a free or upper end of the stave. An advantage provided by this embodiment is that the cutting edge is successively moved from grinding by coarser material to polishing by finer material where after the cutting edge is withdrawn from the tool after completed sharpening process.

In one embodiment, each of the primary and secondary treatment areas are planar within its margins. A technical effect provided by this embodiment is that wear is distributed over the whole width of the treatment areas.

It is preferred that the primary and secondary treatment areas meet at the same level, or in other words, that a transition between the primary and secondary treatment areas is continuous and stepless. In result, the cutting edge can be moved between the treatment areas without cutting into any irregularities.

Advantageously, the secondary treatment area effective for grinding comprises a coating with diamond or other abrasive material, whereas the primary treatment area effective for polishing comprises a ceramic material.

In a second aspect of the invention, briefly, there is provided a tool assembly for grinding and polishing/honing in combination, comprising first and second grinding- and polishing tools individually mounted in separate holders respectively, the holders located side by side and movable back- and forth in parallel and mutually opposite directions, wherein the grinding- and polishing tools carry oppositely facing edge treatment areas and extend inclined from the holders at intersecting directions, forming between them a V-shaped groove for the simultaneous treatment of opposite sides of a cutting edge when inserted and set in motion in the groove.

The V-shaped groove defined by the grinding- and polishing tools comprises an entrance region having an intermediate angle between treatment areas which is other than an intermediate angle between treatment areas in a bottom region of the groove. The entrance and bottom regions of the groove may each amount to approximately half the length of the grinding- and polishing tools.

In a similar way as previously explained, forming the primary and secondary edges is accomplished in a continuous operation using the same tool assembly unchanged, simply by changing the depth of insertion of the cutting edge in the groove.

In one embodiment, the intermediate angle between treatment areas at the entrance region of the groove is greater than the intermediate angle between treatment areas at the bottom region of the groove. The intermediate angle at the entrance region may be 1°-7° greater than the intermediate angle at the bottom region of the groove.

In an alternative embodiment, the intermediate angle between treatment areas at the entrance region of the groove is less than the intermediate angle between treatment areas at the bottom region of the groove. The intermediate angle at the entrance region may be 1°-7° less than the intermediate angle at the bottom region of the groove.

In a third aspect of the invention, briefly, there is provided an attachment for grinding and polishing/honing in combination of a circular cutting blade having a cutting edge formed circumferentially thereon, said cutting blade associated with an abutment plate which is adjustable for positioning in different planes in parallel with the cutting blade. The attachment comprises a guide for a movably suspended tool assembly comprising grinding- and polishing tools configured for grinding the cutting edge to a first edge angle and successively for polishing/honing the cutting edge to a second edge angle which is greater than the first edge angle, wherein said attachment is detachably mountable to the abutment plate and arranged for positively controlling the tool assembly in movement in a plane or direction that is parallel to or coincident with the plane or direction of the cutting blade.

The novel solutions for grinding tools and apparatuses disclosed herein enables a new method for treating a cutting edge of a circular cutting blade in a food slicer machine while rotating the cutting blade in the food slicer machine, using the grinding- and polishing tools, the tool assembly or the attachment as explained and claimed below.

Other details, technical features and embodiments of the different aspects of the invention will appear from the dependent claims, the drawings and from the following detailed description of embodiments.

### SHORT DESCRIPTION OF THE DRAWINGS

The different aspects of the invention are illustrated schematically in the drawings, of which

FIG. 1 shows, in exploded view, a tool assembly comprising grinding- and polishing tools of a first embodiment, with associated holders,

FIG. 2 shows the grinding- and polishing tools in starting position for treatment of a cutting edge formed in the periphery of a circular cutting blade,

FIG. 3 shows the position of the cutting blade in the grinding- and polishing tools during grinding,

FIG. 4 shows the position of the cutting blade in the grinding- and polishing tools during polishing/honing,

FIG. 5A/5B show an attachment for grinding and polishing/honing of a cutting blade in a food slicer machine, in dismounted and mounted positions respectively,

FIG. 6 shows the attachment of FIG. 5 in an initial position,

FIG. 7 shows the attachment of FIGS. 5 and 6 in working position,

FIG. 8 shows a setting gauge mountable to the attachment,

FIG. 9 shows the attachment of FIG. 8 in a phantom view,

FIGS. 10A-C show, in three positions, a grinding- and polishing attachment of alternative design suspended for swinging adjustment with respect to a cutting blade in a food slicer machine,

FIGS. 11A-B show the sequential steps in formation of secondary and primary edges in a grinding- and polishing tool of the first embodiment, and

FIGS. 12A-B show the sequential steps in formation of secondary and primary edges in a grinding- and polishing tool of a second embodiment.

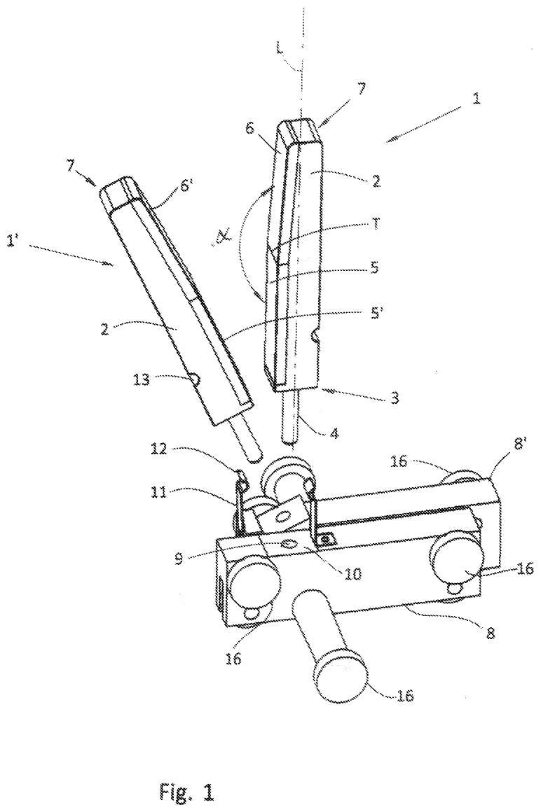

### DETAILED DESCRIPTION OF PREFERRED EMBODIMENTS

A grinding- and polishing tool 1 or 1′ comprises an elongate stave-shaped element 2 which has, in a mounting end 3, a fastening means such as a pin 4 for mounting the stave 2 in a holder member. Even if the stave 2 of this embodiment is shown to have four sides, a grinding- and polishing tool of the invention may in other applications alternatively include three sides or more sides than four, if appropriate. At least one side of the stave 2 carries edge treatment materials of different surface roughness and different abrasive efficiency for grinding and for polishing/honing, respectively, of a cutting edge, utilizing the very same side of the stave. More precisely, looking at the tool 1, the said side of the stave comprises a primary treatment area 6 which has a surface roughness and abrasive capability effective for polishing/honing and thus forming a primary edge, and adjoining thereto in the length direction L of the stave, a secondary treatment area 5 having a surface roughness and abrasive capability effective for grinding and thus forming a secondary edge to the cutting edge.

An edge treatment area suitable for grinding may have a coating of hard material such as diamond or other kind of abrasive mineral, and an edge treatment area suitable for polishing or honing may have a ceramic coating. Alternatively, the treatment areas 5 and 6 may both include ceramic material of different abrasive efficiency. One or both treatment areas can be formed onto separate plates attached to the stave 2. The stave 2 can be seen as tool core which can be shaped in plastic, metal or ceramics, e.g. In the latter case, the treatment area 6 may form an integer part of a stave 2 made in ceramics.

The treatment areas 5 and 6 may each amount to about half the length of the stave 2. In a first embodiment of the invention, the treatment area 5 adapted for grinding reaches from said mounting end 3 towards the longitudinal centre of the stave, whereas the treatment area 6 adapted for polishing/honing reaches from an opposite end 7 towards the longitudinal centre of the stave. It shall here be emphasized that the expression “longitudinal centre” is not to be interpreted as meaning that each treatment area must necessarily amount to exactly half the length of the stave: as a rule of thumb it can be assumed that one of the treatment areas 5 or 6 reaches from 30 to 70 percent, or preferably from 40 to 60 percent of the total length of the stave.

Independently of the actual lengths of the treatment areas 5 and 6, a transition T between the treatment areas should be free from any discontinuation, in other words be continuous and stepless, at least with respect to the transfer of the cutting edge past the transition from one treatment area to the other without getting caught.

In order to meet the object of providing a grinding- and polishing tool in combination, the treatment areas 5 and 6 are oriented at mutually intersecting planes. In other words, a fixed angle α is formed between the treatment areas 5 and 6, this angle being other than 180° (as, in this context, 180° is considered defining a straight line or a continuous plane).

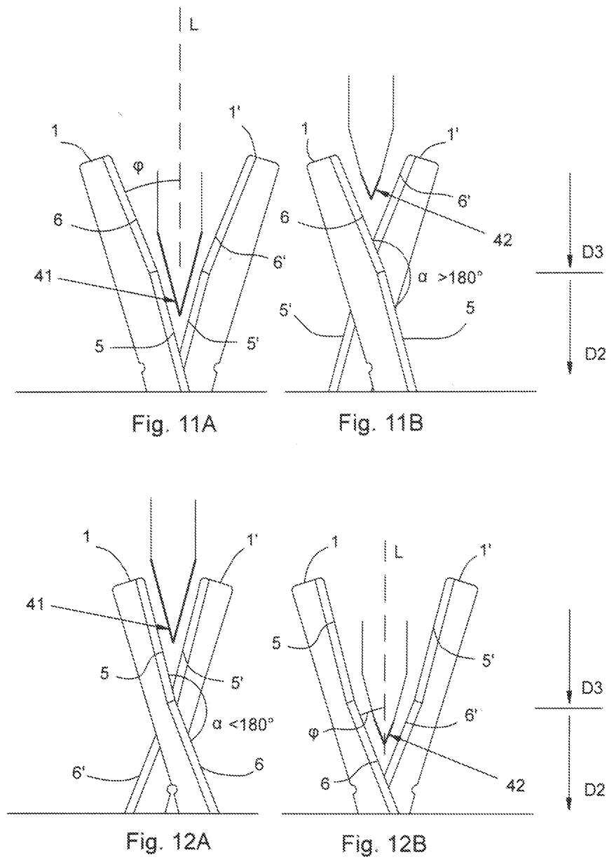

In a preferred embodiment, see also FIGS. 11A and 11B, the intermediate angle α is greater than 180°, advantageously in the range of 180.5°-183.5°. Explained in other way, the treatment area 6 (polishing) is leaning and inclined with respect to the longitudinal axis L at a tilt angle φ which is in the order of 0.5°-3.5° greater than a corresponding tilt angle between the longitudinal axis L and the treatment area 5 (grinding).

In an alternative embodiment, see FIGS. 12 A and 12B, the intermediate angle α is less than 180°, advantageously in the range of 176.5°-179.5°. However, since in this alternative embodiment the consecutive order of treatment areas 5 and 6 is shifted in the length direction of the stave, the treatment area 6 (polishing) is still inclined with respect to the longitudinal axis L at a tilt angle φ which is in the order of 0.5°-3.5° greater than the corresponding tilt angle between the longitudinal axis L and the treatment area 5 (grinding).

The grinding- and polishing tool 1 is associated with a holder member 8 which is formed with a bore 9 for insertion of the pin 4 that projects in the mounting end 3 of the stave. In mounted position, the lower tool end 3 rests against a shoulder 10 in an upper face of the holder 8. A spring 11 reaches upwards from the holder, the spring comprising a heel 12 which in mounted state engages a recess 13 that is formed in a rear side of the stave 2. By its engagement, the spring 11 arrests the stave to the holder 8, at least axially. It can here be added that the engagement from the heel 12 into the recess 13 can include a play, if appropriate, which provides some pivoting of the stave about the longitudinal axis L in the mounted state of the stave.

A tool assembly 14 for grinding and polishing/honing of a cutting edge comprises a pair of grinding- and polishing tools 1 and 1′, individually mounted in separate holders 8 and 8′ respectively. The holders 8, 8′ are movably accommodated side by side for back and forth movements in parallel and straight paths and directions R1 in a housing 15. In the illustrated embodiment, the holders 8, 8′ are journaled on wheels or rollers 16 which can be arranged to run guided in rails (not shown) formed in a bottom panel of the housing 15. However, the holders 8, 8′ may alternatively be accommodated for sliding motion in the housing 15.

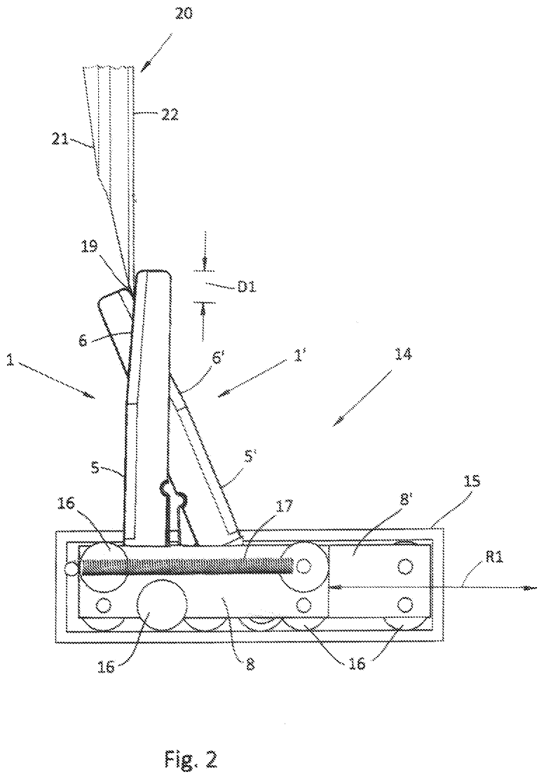

In the tool assembly 14, the grinding- and polishing tools 1 and 1′ reach from the holders 8, 8′ at intersecting directions with oppositely facing treatment areas 5, 5′ and 6, 6′ respectively, forming between them a V-shaped groove which has the sectional shape of an edge profile for the simultaneous treatment of both sides of a cutting edge when inserted in the groove and set in rotation or in reciprocating movement while in contact with the treatment areas. Compression- or tension springs 17 and 18 may be arranged in the housing 15 for biasing the holders 8 and 8′ in mutually opposite directions towards an initial position, see FIG. 2, in which the groove remains open to a minor depth D1, yet sufficient for insertion of a cutting edge between the tools.

In the drawings, the cutting edge in question is the cutting edge 19 formed about the circumference of a circular cutting blade 20.

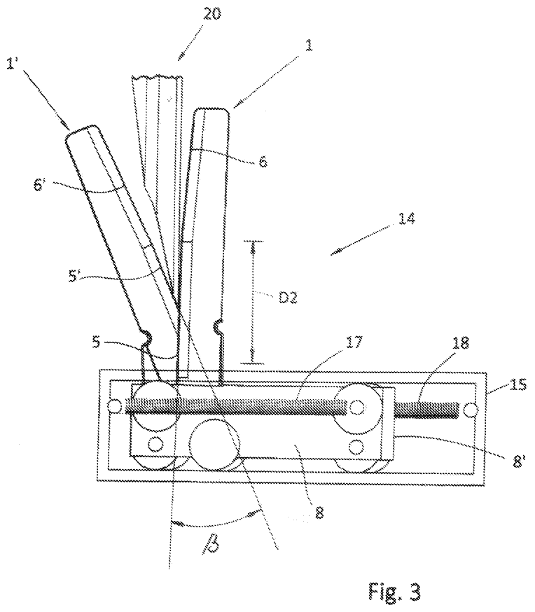

With reference to FIG. 3, the tool assembly 14 and the cutting blade 20 are shown during a grinding sequence. During grinding, the cutting blade 20 is inserted to an insertion depth D2 in which the cutting blade can be rotated in contact with the treatment areas 5 and 5′ for simultaneous grinding of both sides of the cutting edge 19. An intermediate angle β between the treatment areas 5, 5′ in this bottom region (D2) of the groove can amount to an order of 25°-45°, and is often in the range of 30°-40°. In other words, grinding in the tool assembly 14 results in a raw edge having an edge angle β, in this context also named a secondary edge (see secondary edge 41 illustrated by heavy lines in FIG. 11A).

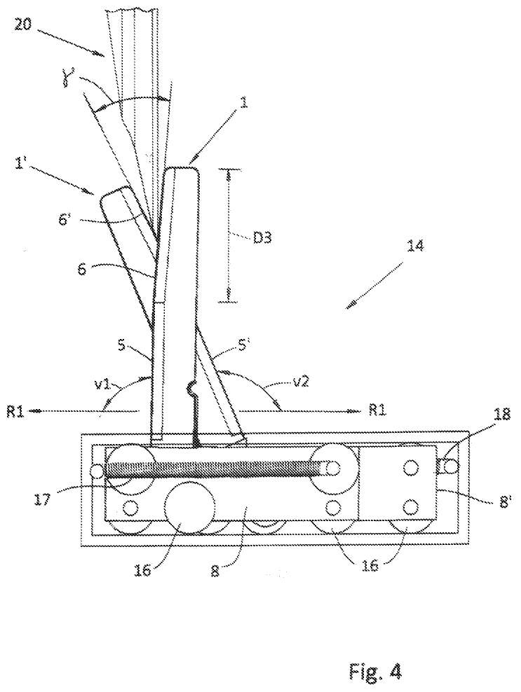

With reference to FIG. 4, the tool assembly 14 and cutting blade 20 are shown during a polishing/honing sequence. During polishing or honing of the raw edge, the cutting blade 20 is inserted to an insertion depth D3 at which the cutting blade can be rotated in contact with the treatment areas 6 and 6′ for simultaneous polishing/honing of both sides of the cutting edge 19. An intermediate angle γ between the treatment areas 6, 6′ in this entrance region (D3) to the groove is greater than the angle β in the bottom region of the groove. The angle γ in the entrance region (D3) to the groove is preferably about 1°-7° greater than the angle β in the bottom region (D2) of the groove. By polishing/honing in the tool assembly 14, the raw edge is removed and formed to an edge angle γ, in this context also named primary edge (see primary edge 42 illustrated by heavy lines in FIG. 11B). The edge angle of the primary edge 42 is thus more obtuse than the edge angle of the secondary edge 41.

In the cutting blade 20 shown in this disclosure, one side of the cutting edge 19 comprises a circumferential region of a convex side 21, the opposite side 22 of the blade being essentially planar (see FIG. 2). The shape of the cutting blade 20 makes is suitable for use in a food slicer machine, wherein the convexly shaped side pushes a separated food slice away from the cutting blade. For clarity reasons it needs here to be explained, that the sectional profile of the cutting edge 19 per se is of V-shape, having planar faces on both sides of the cutting blade 20. However, the present invention is not restricted to implementation with circular cutting blades in food slicer machines.

In a tool assembly 14 adapted for grinding and polishing the cutting edge 19 of the cutting blade 20, the grinding- and polishing tools 1, 1′ are oriented in adaptation to the sectional shape of the cutting blade. To this purpose, see FIG. 4, one of the tools (1) extends at straight or nearly straight angle v1 with respect to the movement direction R1, for treatment of that part of the cutting edge 19 which is located on the planar side 22. On the other hand, the other tool (1′) is inclined at a slanting angle v2 with respect to the movement direction R1, this angle being adapted to the inclination of that part of the cutting edge 19 which is formed on the convex side 21 of the cutting blade 20.

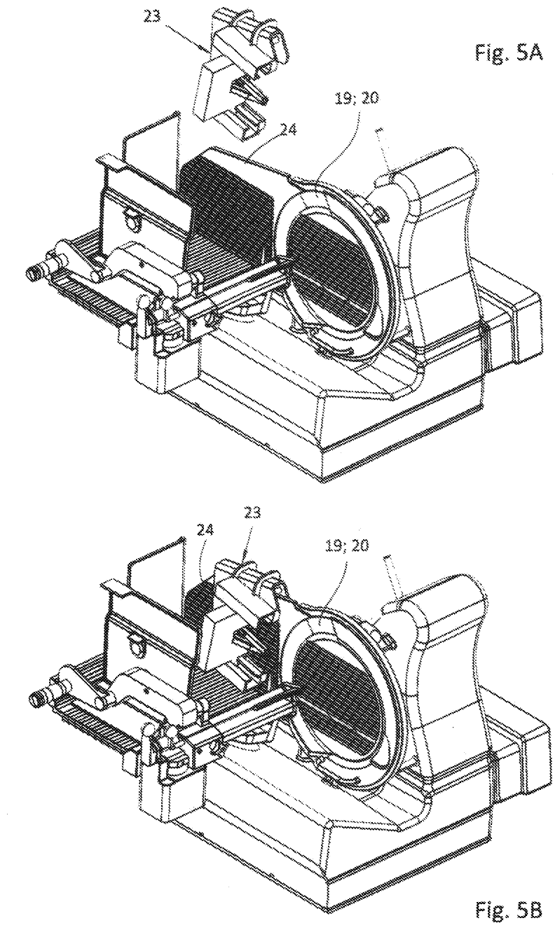

Now shall be described, with reference made to FIGS. 5-9, a grinding- and polishing attachment 23 arranged for sharpening the edge of a cutting blade while mounted in a food slicer machine. It should briefly be explained, with reference made to FIGS. 5A and 5B, that a food slicer machine typically includes a circular cutting blade 20 having a cutting edge 19 formed on its circumference, as well as an abutment plate 24 associated and aligned with the cutting blade. The abutment plate 24 is movable to different planes in parallel with the cutting blade, for adjustment of the thickness of food slices.

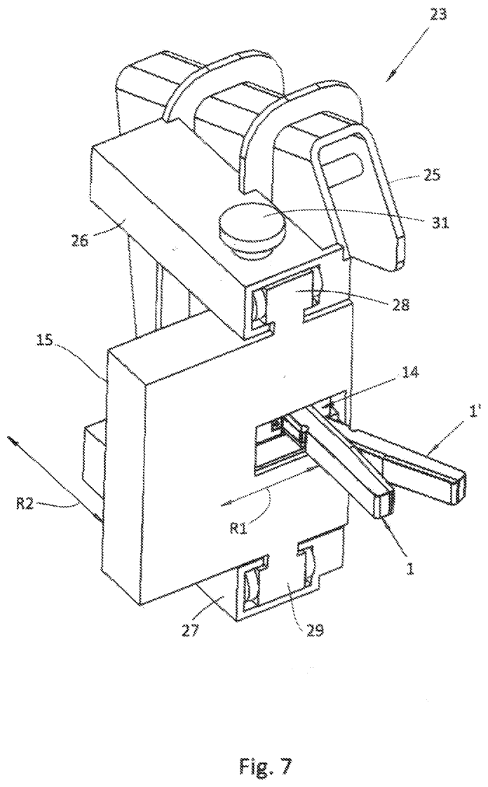

The grinding- and polishing attachment 23 comprises a clamp 25 by which the attachment 23 is detachably mountable to an abutment plate 24. In mounted position on the abutment plate, an upper guide rail 26 of the attachment 23 is aligned in parallel with the abutment plate 24. A corresponding lower guide rail 27 is arranged accordingly in alignment with the abutment plate 24, and thus in alignment with the upper rail 26. A housing 15, arranged for accommodation of a tool assembly 14 movable in the housing, is suspended in the attachment 23 by means of an upper suspension means 28 which is movably journaled in the upper guide rail 26, see FIG. 7. A corresponding lower suspension means 29 may likewise be movably journaled in the lower guide rail 27. The suspension means 28, 29 can be realized in the form of T-bar sections connected to the housing and equipped with wheels or rollers as illustrated in FIG. 7, but may alternatively be realized in the form of sliding suspension means.

In mounted position on the abutment plate 24, the attachment 23 provides guidance for the movements of the housing 15 in the direction of R2 which is parallel to the abutment plate 24 and the cutting blade 20, and essentially radial with respect to the cutting blade 20. The tool assembly 14 is arranged with the grinding- and polishing tools 1, 1′ spring-biased to move back- and forth in the housing 15 in the direction of R1, which runs in parallel with the rotary axis of the cutting blade 20, and which thereby intersects with, essentially under straight angles, the direction R2.

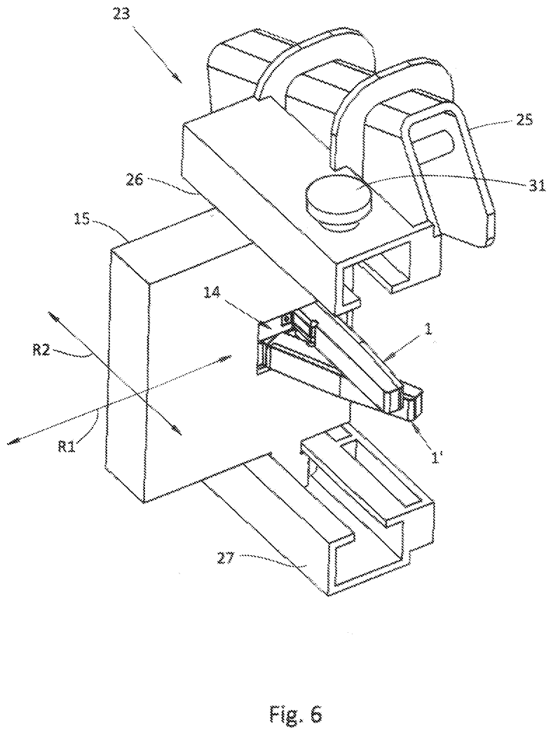

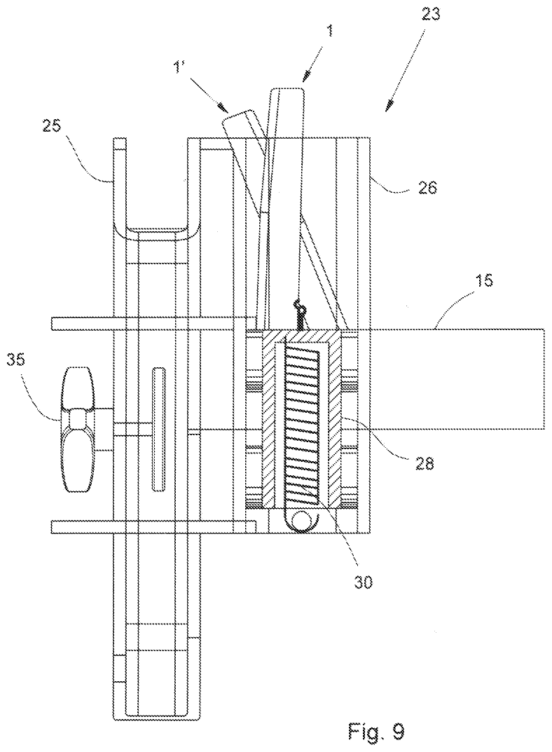

A tension spring 30, see FIG. 9, can be anchored in the guide rail 26 and attached to the suspension means 28. A corresponding tension spring can be attached to the suspension means 29 and anchored in the guide rail 27. The tension spring 30 is operative for returning the housing 15 to a withdrawn initial position (as of FIG. 6) after completed treatment process.

For grinding and polishing/honing of the cutting blade 20, the housing 15 with the tool assembly 14 can be moved in the direction of R2 so that the cutting edge 19 of the cutting blade is received in the V-shaped groove defined by the grinding- and polishing tools 1, 1′, in order to be successively brought in working contact with the treatment areas 5, 5′ and 6, 6′ respectively.

In a first step (FIG. 3), the attachment 23 is advanced until the cutting edge 19 is positioned between the treatment areas 5 and 5′ for grinding and forming of the secondary edge under rotation of the cutting blade. In a following step (FIG. 4), under continued rotation of the cutting blade if appropriate, the attachment 23 is withdrawn until the cutting edge 19 is positioned between the treatment areas 6 and 6′ for polishing/honing and forming of the primary edge under rotation of the cutting blade. By operation of the springs 17 and 18, the tools 1, 1′ are biased towards each other in the direction of R1, this way constantly applying a contact pressure against the cutting edge 19 from both sides.

In order to positively define the positions of the tool assembly 14 during grinding and polishing/honing respectively, a switch means may be arranged to operate between the attachment 23 and the housing 15. For example, a switch 31 may be realized in the form of a pin which is journaled in the guide rail 26 and by twisting or depressing can be lowered in order to block the travel of the housing 15 in the guide rail 26 at either insertion depth D2 or D3.

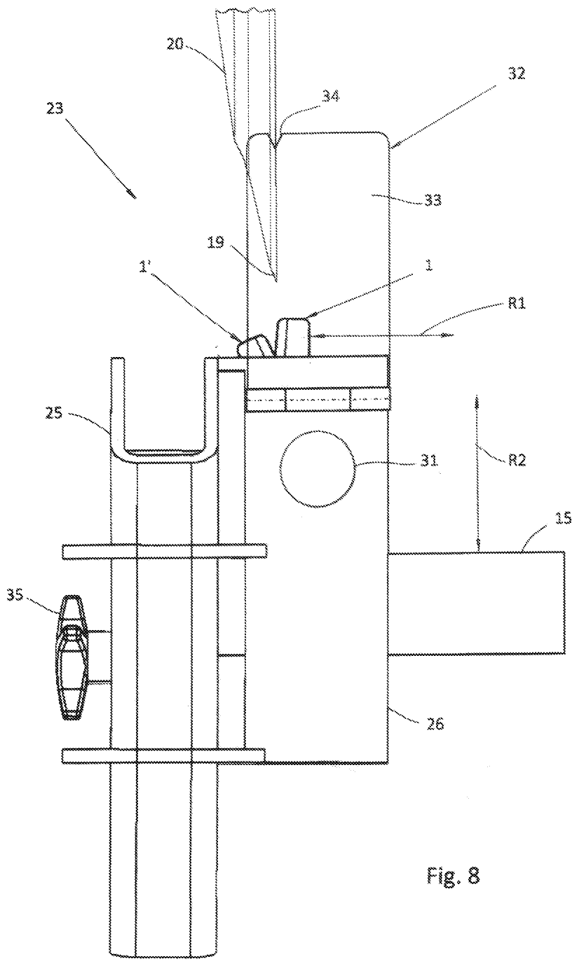

Next, a gauge for adjustment of the tool assembly 14 with respect to the cutting blade 20 will be described with reference to FIG. 8. A gauge 32 comprises a pivotally connected holder 33 for a marker, the holder being detachably connectable to the attachment 23. The holder holds a marker 34 in a forward end facing the cutting blade 20. The marker can be realized as a visual mark printed on the holder, or realized in the form of a recess placed in the forward end of the holder. Accordingly, the gauge and marker indicate the positions of the grinding- and polishing tools 1, 1′ in the tool assembly 14. When mounting the gauge to the attachment 23, the marker is positioned vertically above the entrance region of the groove that is defined between the grinding- and polishing tools 1 and 1′ in the initial position depicted in FIG. 2 and FIG. 6. The holder 33 can be dimensioned to hold the marker 34 in an advanced position with respect to the tools 1 and 1′, in the direction of R2, this way ensuring that the cutting blade will be brought into contact with the gauge and marker before it comes into contact with the grinding- and polishing tools. Advantageously, the holder 33 is made to such length that the grinding- and polishing tools 1 and 1′ will be placed in the initial position for edge treatment simultaneously as the gauge/marker is placed in contact with the cutting blade.

Adjustment of the attachment 23 is accomplished by moving the abutment plate 24 until the marker is positioned in alignment with the cutting blade, which is ensured either by visual control or alternatively accomplished by positioning the abutment plate 24 at a predetermined value on a scale for food slice thickness. In a following step, the attachment 23 is moved forward along the abutment plate 24 towards the cutting blade into a position wherein the cutting edge/cutting blade 19, 20 can be freely rotated without contacting the grinding- and polishing tools 1 and 1′, whereupon the attachment 23 is fixated on the abutment plate 24 by means of a set screw 35. The gauge 32 can then be pivoted away or be detached before initiating treatment of the edge by bringing the cutting blade to rotate while moving the housing 15 and tools 1, 1′ forward into operative contact with the cutting blade. During both operations of grinding and polishing/honing, the housing can be moved back- and forth in the direction of R2 this way, on one hand, using a larger portion of the treatment areas 5, 5′ and 6, 6′ when treating the cutting edge, and on the other hand adding a filing effect which further adds to an efficient treatment, if appropriate.

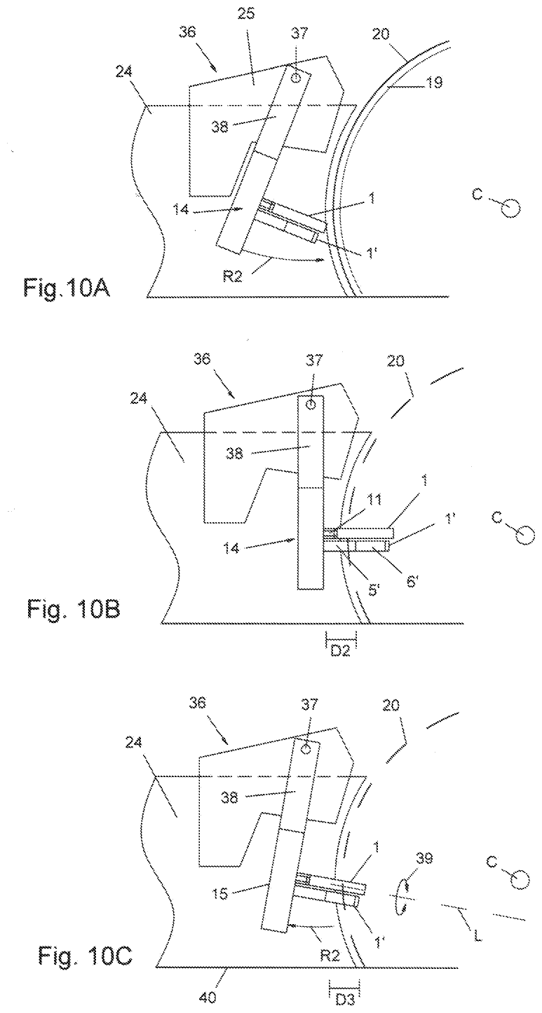

An alternative embodiment of the grinding- and polishing attachment will now be described with reference made to FIGS. 10A-C and the reference number of 36. Similar to the grinding- and polishing attachment 23, the grinding- and polishing attachment 36 comprises a clamp 25 by which the attachment 36 is detachably mountable to an abutment plate 24 in a food slicer machine. In the attachment 36, the tool assembly 14 is pivotally journaled on a pivot 37 which extends from the clamp 25 in parallel relation to the rotational axis C of the cutting blade 20. This way, the tool assembly 14 is positively guided in a plane parallel to the abutment plate 24, at right angles to the rotational axis C, and in an essentially radially directed swinging motion R2 with respect to the cutting blade 20 and the cutting edge 19. More precisely, the tool assembly 14 is suspended in a pendulum arm 38 which has a length from the pivot axis 37 that is adapted to control the tool assembly in an arcuate path which meets the circumference of the cutting blade in mainly a radially directed motion.

Similar to the previous embodiment, the grinding- and polishing tools 1 and 1′ are mutually movable in parallel and opposite directions R1, perpendicularly to the pendulum motion R2, for positioning with respect to the depths of insertion D2, D3 during grinding and polishing/honing, respectively.

In other words, FIG. 10A shows the tools 1 and 1′ in the initial start position out of engagement with the cutting edge 19. In FIG. 10B the tool assembly 14 is swung forward to an insertion depth D2 at which the treatment areas 5 and 5′ engages the cutting edge for grinding. In FIG. 10C the tool assembly 14 is swung back to the insertion depth D3 at which the treatment areas 6 and 6′ engage the cutting edge for polishing or honing. It should be noticed that in FIGS. 10B and 10C the position of the cutting blade 20 is merely indicated through a dashed line, since in practise the cutting blade, in these positions, would otherwise hide the tool 1′ which extends partly on the farther side of the cutting blade in this view.

A spring member (not shown) may be arranged in order to return the tool assembly 14 to the initial position shown in FIG. 10A. For example, a spring member may for this purpose be realized in the form of a torsion spring that is mounted in connection with the journal of the pendulum arm 38 on the pivot axis 37.

It will be advantageous if the grinding- and polishing tools 1 and 1′ in the attachment 36 are permitted a certain amount of pivoting 39 about their longitudinal axes L, in order this way to position the treatment areas 5, 5′; 6,6′ in full surface contact with the cutting edge in all operative positions of the swinging attachment 36.

The disclosed latter embodiment results in a reduced building height, since a need for suspension of the tool assembly 14 from guides can be avoided, which in turn increases the free space and distance underneath the tool assembly 14 with respect to a base 40 in the food slicer machine.

Although the invention has been disclosed above in connection with an asymmetric cutting edge of a circular cutting blade it shall be understood that the invention serves equally well for treatment of cutting edges of symmetric sectional shapes.

To this point of the description, the combined grinding-and polishing tool 1, 1′ has been disclosed with reference to an embodiment, see also FIGS. 11A and 11B, wherein the secondary and primary treatment areas 5 and 6 are mutually inclined so as to form an intermediate angle α of more than 180° between them in the edge treating side of the stave 2. From a manual handling point of view this embodiment is considered to provide highest consistency in edge quality, resulting from a process wherein the initial step of forming a secondary edge 41 is accomplished by using grinding treatment areas 5, 5′ defining a bottom region of the V-shaped groove, whereas in the final step a primary edge 42 is accomplished by using finer treatment areas 6, 6′ defining an entrance region of the groove.

However, with reference to FIGS. 12A and 12B, an alternative embodiment foresees that the consecutive order of the primary and secondary treatment areas are shifted in the length direction of the staves, and are mutually inclined so as to form an intermediate angle α of less than 180° between them in the edge treating side of the stave. In contrast to the first embodiment, the initial step resulting in a secondary edge 41 is here first completed by using treatment areas 5, 5′ of coarser surface roughness in an entrance region of the V-shaped groove, whereas in a final step a primary edge 42 is formed in the bottom region of the groove, using treatment areas 6, 6′ of finer surface roughness.

Albeit disclosed herein as a manually operated grinding- and polishing tool, tool assembly and attachment, it will be possible to modify the tool, tool assembly and attachment for a power-driven movement in and out of engagement with a cutting edge to be ground and polished/honed in one continuous procedure. Since such modification is achievable without applying inventive skill, the invention is not to be limited to manually operated use and, accordingly, the appended claims shall be understood to include both manual and powered implementations of the invention.

1. A grinding- and polishing tool in combination, comprising a stave which has an edge-treatment side comprising a primary treatment area covering a part of its length, and which in the length direction of the stave is followed by an adjoining secondary treatment area covering another part of the length of the stave, wherein the treatment areas are oriented at intersecting planes such that an intermediate angle between adjoining primary and secondary treatment areas is other than 180°.

2. The grinding- and polishing tool of claim 1, wherein the secondary treatment area has a coarser surface roughness than the primary treatment area.

3. The grinding- and polishing tool of claim 1, wherein each of the primary and secondary treatment areas is planar within its margins.

4. The grinding- and polishing tool according to claim 1, wherein a transition between the treatment areas is continuous and stepless.

5. The grinding- and polishing tool of claim 1, wherein the secondary treatment area effective for grinding comprises a coating with diamond or other abrasive material, whereas the primary treatment area effective for polishing comprises a ceramic material.

6. The grinding- and polishing tool of claim 1, wherein the intermediate angle between the primary and secondary treatment areas is greater than 180°, and preferably lies in the range of 180.5°-183.5°.

7. The grinding- and polishing tool of claim 6, wherein the secondary treatment area reaches from a mounting end of the stave towards a longitudinal center of the stave, whereas the primary treatment area reaches towards the longitudinal center of the stave from an opposite end of the stave.

8. The grinding- and polishing tool of claim 1, wherein the intermediate angle between the primary and secondary treatment areas is less than 180°, and preferably lies in the range of 176.5°-179.5°.

9. A tool assembly for grinding and polishing/honing in combination, comprising first and second grinding- and polishing tools individually mounted in separate holders respectively, the holders located side by side and movable back- and forth in mutually opposite, parallel directions, wherein the grinding- and polishing tools carry oppositely facing edge treatment areas and extend inclined from the holders at intersecting directions, forming between them a V-shaped groove for the simultaneous treatment of opposite sides of a cutting edge when inserted and set in motion in the groove, wherein the groove defined by the grinding- and polishing tools comprises an entrance region having an intermediate angle between treatment areas which is other than an intermediate angle between treatment areas in a bottom region of the groove.

10. The tool assembly of claim 9, wherein the angle between treatment areas in the entrance region of the groove is greater than the angle between treatment areas in a bottom region of the groove, and preferably 1°-7° greater.

11. The tool assembly of claim 10, wherein the bottom region of the groove is defined by edge treatment areas of coarser surface roughness effective for grinding, whereas the entrance region of the groove is defined by edge treatment areas of finer surface roughness effective for polishing/honing.

12. The tool assembly of claim 9, wherein the angle between treatment areas in the entrance region of the groove is less than the angle between treatment areas in a bottom region of the groove, and preferably 1°-7° less.

13. The tool assembly of claim 12, wherein the bottom region of the groove is defined by edge treatment areas of finer surface roughness effective for polishing/honing, whereas the entrance region of the groove is defined by edge treatment areas of coarser surface roughness effective for grinding.

14. The tool assembly of claim 9, wherein the entrance region of the groove extends to substantially half the depth of the groove, as seen from the entrance towards the bottom region of the groove.

15. The tool assembly of claim 9, wherein the holders are accommodated in a housing and spring-biased in opposite directions for simultaneously applying a pressure from both sides to a cutting edge when inserted in the groove for treatment.

16. An attachment for grinding and polishing/honing in combination of a circular cutting blade having a cutting edge formed circumferentially thereon, said cutting blade associated with an abutment plate which is adjustable for positioning in different planes in parallel with the cutting blade, comprising a guide for a movably suspended tool assembly comprising grinding- and polishing tools configured for grinding the cutting edge to a first edge angle and successively for polishing/honing the cutting edge to a second edge angle which is greater than the first edge angle, wherein said attachment is detachably mountable to the abutment plate and arranged for positively controlling the tool assembly in movement in a plane and direction that is parallel to or coincident with the plane and direction of the cutting blade.

17. The attachment of claim 16, comprising:
a clamp for coupling a guide rail in parallel alignment with the abutment plate,
a housing arranged movable in the guide rail and in which the tool assembly is arranged movable in a direction transversely to the direction of the cutting blade.

18. The attachment of claim 17, wherein the housing is spring-biased away from the cutting blade.

19. The attachment of claim 17, comprising a switch operating between the attachment and the housing, the switch controlling, by its position, the positions of the housing in the guide rail.

20. The attachment of claim 17, comprising a gauge having a marker that indicates the position of the grinding- and polishing tools in the housing, wherein the marker can be aligned with the cutting blade by adjusting the position of the abutment plate.

21. The attachment of claim 16, comprising:
an axis aligned in parallel with a rotational axis of the cutting blade,
a pendulum arm pivotally journaled on the axis,
a tool assembly suspended in a free end of the pendulum arm,
wherein the length of the pendulum arm from the axis is determined for positively controlling the tool assembly in an arcuate path which meets the periphery of the cutting blade in an essentially radially directed motion with respect to the cutting blade.

22. The attachment of claim 14, wherein the tool assembly comprises grinding- and polishing tools which are pivotally journaled about their longitudinal axes in holders.

23. A method of treating a cutting edge of a circular cutting blade in a food slicer machine using a grinding- and polishing tool, a tool assembly or an attachment according to claim 9, while rotating the cutting blade in the food slicer machine.
